(19) United States
(12) Patent Application Publication
(10) Pub. No.: US 2018/0363262 A1
(43) Pub. Date: Dec. 20, 2018

(54) DREDGING TUBE SYSTEM

(71) Applicant: Kuo-Chang HUANG, Tainan City (TW)

(72) Inventor: Kuo-Chang HUANG, Tainan City (TW)

(21) Appl. No.: 16/006,130

(22) Filed: Jun. 12, 2018

(30) Foreign Application Priority Data
Jun. 14, 2017 (TW) 106119802

(51) Int. Cl. E02B 3/02; B01D 21/00

(52) U.S. Cl. CPC E02B 3/023; B01D 21/006; B01D 21/0042

(57) ABSTRACT

A dredging tube system includes a tube unit and a plurality of spaced-apart sediment-trapping units. The tube unit includes a tube structure that has an inner surrounding surface surrounding a longitudinal axis. The sediment-trapping units are mounted fixedly on the inner surrounding surface and are arranged along the longitudinal axis. Each of the sediment-trapping units includes a plurality of sediment-trapping members that cooperatively form an annular ring structure. Each of the sediment-trapping members has an abutment portion that has a curved outer surface entirely abutting against the inner surrounding surface of the tube structure, and a projecting portion that extends radially and inwardly from the abutment portion.

### CROSS-REFERENCE TO RELATED APPLICATION

This application claims priority of Taiwanese Patent Application No. 106119802, filed on Jun. 14, 2017.

### FIELD

The disclosure relates to a dredging system, and more particularly to a dredging tube system.

### BACKGROUND

Dredging is an excavation technique commonly performed underwater to maintain the holding capacity of reservoirs and lakes. In places with frequent storm presence, a more advanced dredging tool for reservoirs has been thought after to clean up bottom sediments brought by heavy rainfall from the storm, as traditional dredging technique, such as suction dredging or direct excavation of sediments during drought, cannot clean up the sediments faster than how much more gets incremented.

There exists a dredging method utilizing a reservoir dredging tube system, which includes a dredging tube adapted to be laid on a bottom of a reservoir and a water gate that is mounted in the dredging tube to control the water flow leading to a river downstream. Due to water level difference between the reservoir and the river, when the water gate is open, water in the reservoir will promptly but abruptly carry the sediments deposited therein downstream through the dredging tube. Although the water flow caused by considerable elevation difference can effectively carry the sediments downstream, it is also highly turbulent and rapid, becoming problematic when the sediments within the water flow cause tearing of the interior surface of the dredging tube, jeopardizing service life of the reservoir dredging tube system.

### SUMMARY

Therefore, an object of the disclosure is to provide a dredging tube system that can alleviate the drawback of the prior art.

According to the disclosure, the dredging tube system includes a tube unit and a plurality of spaced-apart sediment-trapping units. The tube unit includes a tube structure that has an inner surrounding surface surrounding a longitudinal axis of the tube structure and defining a tube space adapted for passage of water. The sediment-trapping units are disposed in the tube space, are mounted fixedly on the inner surrounding surface, and are arranged along the longitudinal axis. Each of the sediment-trapping units includes a plurality of sediment-trapping members that cooperatively form an annular ring structure surrounding the longitudinal axis. Each of the sediment-trapping members has an abutment portion that has a curved outer surface entirely abutting against the inner surrounding surface of the tube structure, and a projecting portion that extends radially and inwardly from the abutment portion, such that at least a portion of sediments carried by the water is trapped by the sediment-trapping units as the water flows within the tube space.

### BRIEF DESCRIPTION OF THE DRAWINGS

Other features and advantages of the disclosure will become apparent in the following detailed description of the embodiment with reference to the accompanying drawings, of which:

FIG. 1 is a top view of a first embodiment of a dredging tube system according to the disclosure, illustrating multiple instances of the embodiment on a bottom of a water storage;

FIG. 2 is a fragmentary sectional view of the first embodiment, illustrating the first embodiment being implemented into a water barrier;

FIG. 3 is a fragmentary, partly exploded, and perspective cutaway view of the first embodiment;

FIG. 4 is a fragmentary sectional view of the first embodiment, illustrating a sediment layer being formed therein;

FIG. 5 is a fragmentary enlarged view of FIG. 4;

FIG. 6 is a cross-sectional view of the first embodiment; and

FIG. 7 is a fragmentary, partly exploded, and perspective cutaway view of a second embodiment according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

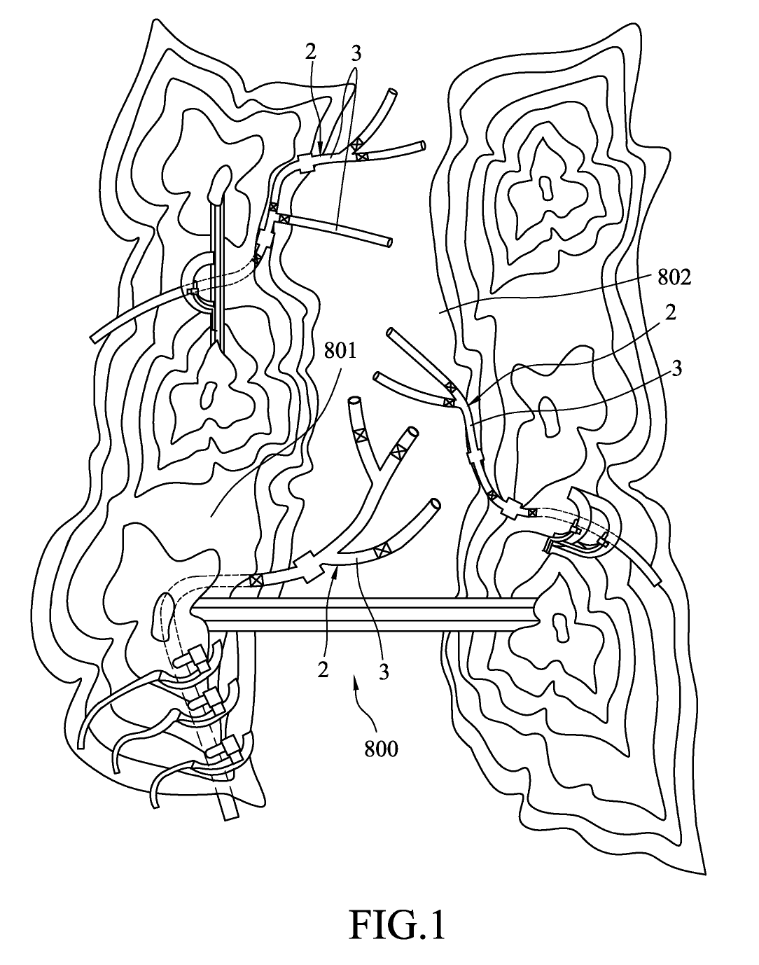

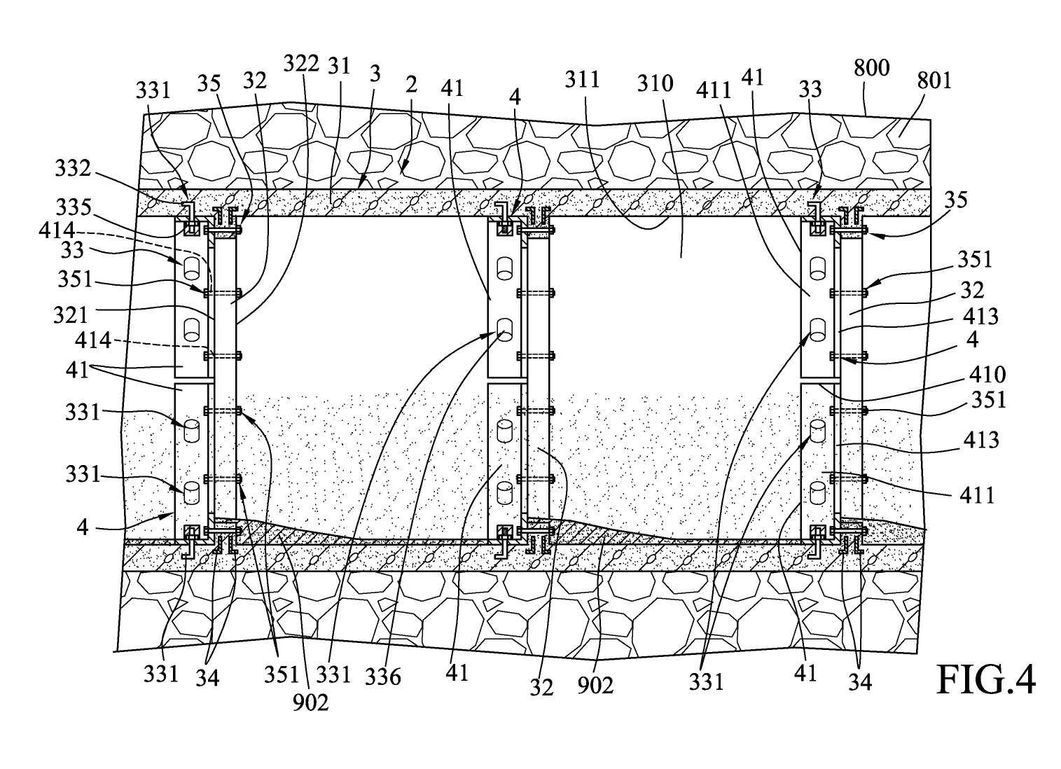

Referring to FIGS. 1, 2 and 4, a first embodiment of a dredging tube system 2 according to the disclosure is adapted to be installed into a water storage 800, such that the dredging tube system 2 may guide sediments 901 carried by water 900 therethrough as the water storage 800 conducts dredging operation. The water storage 800 has a water barrier 801 that defines a storage space 802 for retaining the water 900 therein. In this embodiment, the water storage 800 may be a reservoir or a pond, and the water barrier 801 may be a mixture of natural landscapes and dam(s).

The dredging tube system 2 includes a tube unit 3 that is embedded within the water storage 800 and that defines a tube space 310 adapted for passage of the water 900, and a plurality of spaced-apart sediment-trapping units 4 that are disposed in the tube space 310.

The tube unit 3 includes a tube structure 31, a plurality of annular mounting blocks 32, a plurality of connecting members 34, a plurality of first positioning subunits 35, and a plurality of second positioning subunits 33. The tube structure 31 is mounted in the water barrier 801, and the tube space 310 is fluidly communicated with the storage space 802. The mounting blocks 32 are disposed in the tube structure 31.

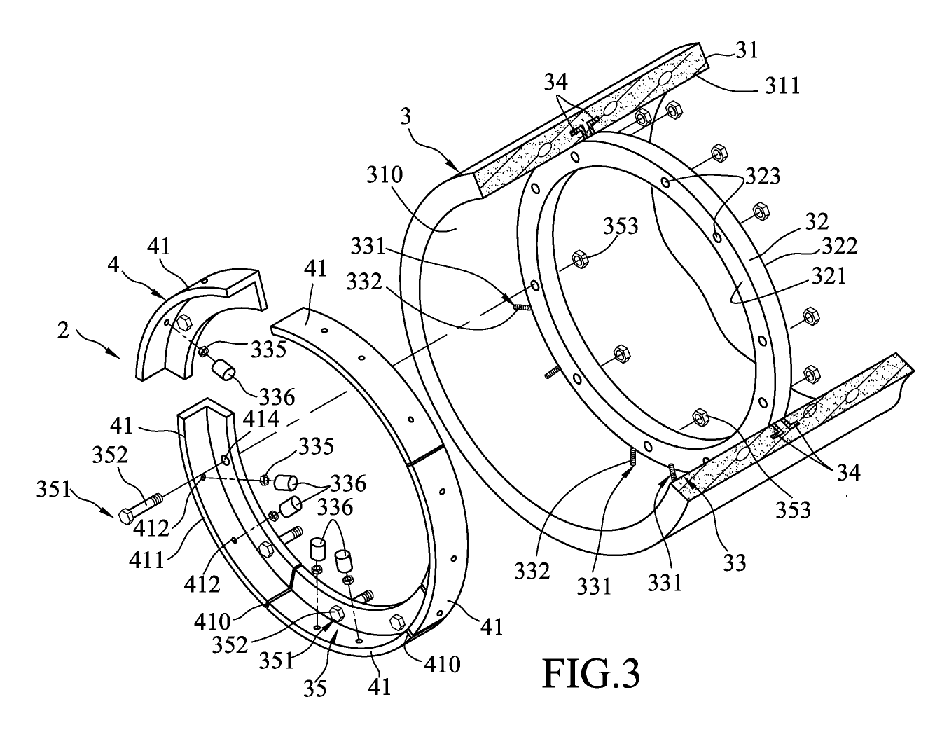

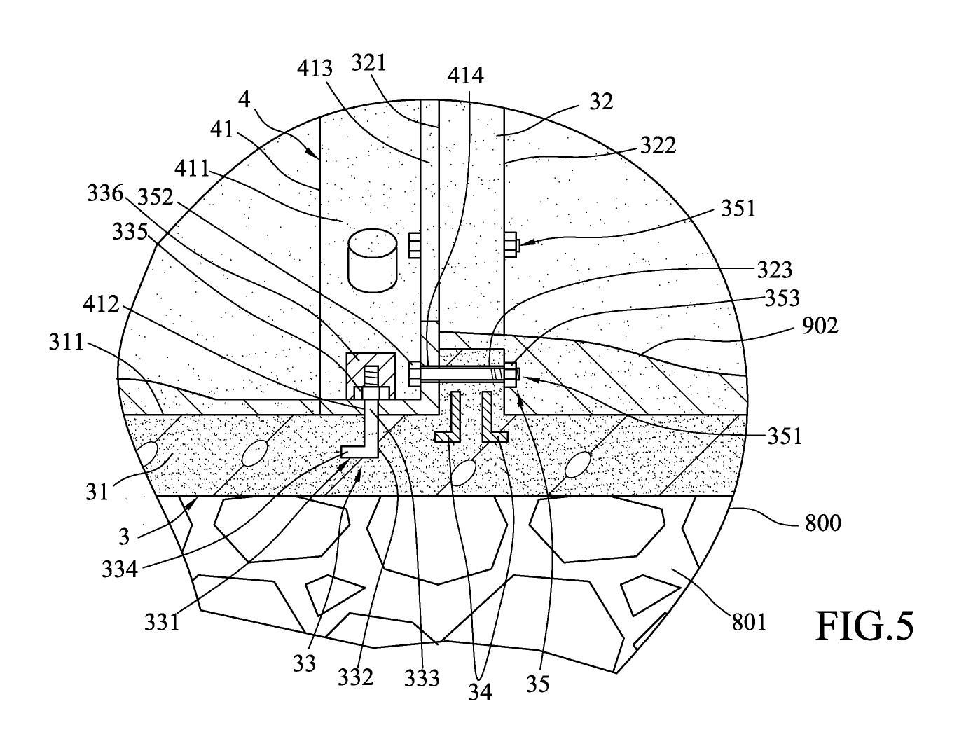

Referring to FIGS. 3 to 5, the tube structure 31 has an inner surrounding surface 311 that surrounds a longitudinal axis of the tube structure 31, and that defines the tube space 310. In this embodiment, the tube structure 31 is a reinforced concrete structure embedded in the water barrier 801. In other embodiments, the tube space 310 may be formed in the water barrier 801 by drilling (i.e., a portion of the water barrier 801 directly forms the tube structure 31).

The mounting blocks 32 are arranged along the longitudinal axis in the tube space 310, and are mounted fixedly on the inner surrounding surface 311. The connecting members 34 connect the mounting blocks 32 to the tube structure 31. Each of the connecting members 34 is embedded in the tube structure 31 and a corresponding one of the mounting blocks 32. In this embodiment, the tube structure 31 and the mounting blocks 32 are reinforced concrete structures molded as one piece, and the connecting members 34 are reinforced steels or bolts that are in the reinforced concrete structures of the tube structure 31 and the mounting blocks 32 before hardening of the reinforced concrete structures of the tube structure 31 and the mounting blocks 32. The connecting members 34 are grouped as a plurality of connecting sets, with the connecting sets being arranged along the longitudinal axis and connected respectively to the mounting blocks 32. For each connecting set, the connecting members 34 are angularly spaced apart, and each connecting member 34 has a portion embedded in the tube structure 31 and another portion embedded in the respective one of the mounting blocks 32. Overall, the addition of the connecting members 34 strengthens the connection between the tube structure 31 and the mounting blocks 32.

Each of the mounting blocks 32 has an upstream surface 321, a downstream surface 322 that is opposite to the upstream surface 321 along the longitudinal axis, and a plurality of angularly spaced-apart locking holes 323 that extends through the upstream surface 321 and the downstream surface 322.

Each of the first positioning subunits 35 is mounted to a respective one of the mounting blocks 32, and includes a plurality of angularly spaced-apart positioning bolt modules 351. In this embodiment, for each of the first positioning subunits 35, each of the positioning bolt modules 351 includes a positioning bolt 352 that extends through a corresponding one of the locking holes 323 of the respective one of the mounting blocks 32, and a positioning nut 353 that engages the positioning bolt 252.

The second positioning subunits 33 are arranged along the longitudinal axis, and are mounted fixedly to the tube structure 31. Each of the second positioning subunits 33 includes a plurality of angularly spaced-apart securing bolt modules 331. For each of the second positioning subunits 33, each of the securing bolt modules 331 includes a securing bolt 332, a securing nut 335 that engages threadedly the securing bolt 332, and a protecting cap 336. The securing bolt 332 has a root segment 334 that is embedded in the tube structure 31 and an engaging segment 333 that extends from the root segment 334 through the inner surrounding surface 311 into the tube space 310. The root segment 334 is transverse to the engaging segment 333. The securing nut 335 engages threadedly the engaging segment 333 of the securing bolt 332. The protecting cap 336 is disposed in the tube space 310, and covers and is coupled to a distal end portion of the engaging segment 333 of the securing bolt 332 and the securing nut 335.

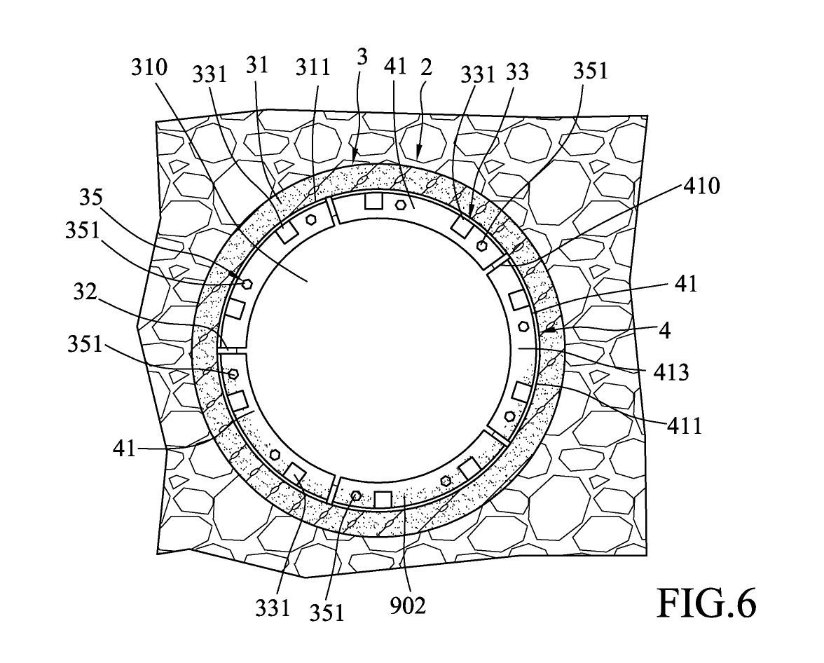

Referring to FIGS. 3, 4 and 6, the sediment-trapping units 4 are arranged along the longitudinal axis in the tube space 310, and are mounted fixedly on the inner surrounding surface 311. Each of the sediment-trapping units 4 includes a plurality of sediment-trapping members 41 that cooperatively form an annular ring structure surrounding the longitudinal axis. Each adjacent pair of the sediment-trapping members 41 defines a gap 410 therebetween.

Each of the sediment-trapping members 41 has an L-shaped cross-section, and has an abutment portion 411 and a projecting portion 413. The abutment portion 411 has a curved outer surface that entirely abuts against the inner surrounding surface 311 of the tube structure 31, and the projecting portion 413 extends radially and inwardly from the abutment portion 411. For each of the sediment-trapping units 4, the projecting portions 413 of the sediment-trapping members 41 abut against the upstream surface 321 of a respective one of the mounting blocks 32. For each of the sediment-trapping units 4, the abutment portion 411 of each of the sediment-trapping members 41 is formed with a plurality of angularly spaced-apart securing holes 412 that extends radially therethrough, and the projection portion 413 of each of the sediment-trapping members 41 is formed with a plurality of positioning holes 414 which extend parallel to the longitudinal axis and each of which is registered with a corresponding one of the locking holes 323 of the respective one of the mounting blocks 32.

In this embodiment, each of the sediment-trapping units 4 includes five of the sediment-trapping members 41. In other embodiment, the number of sediment-trapping members 41 may differ.

In addition, in this embodiment, the sediment-trapping members 41 are made of wear-resistant material such as stainless steel or carbon steel. In other embodiments, the sediment-trapping members 41 may be made of other wear-resistant materials.

For each of the first positioning subunits 35, the positioning bolt 352 of each of the positioning bolt modules 351 engages a corresponding one of the positioning holes 414 of the sediment-trapping members 41 of a respective one of the sediment-trapping units 4 and the corresponding one of the locking holes 323 of the respective one of the mounting blocks 32, and cooperates with the corresponding positioning nut 353 to secure the projection portions 413 of a corresponding one of the sediment-trapping members 41 of the respective one of the sediment-trapping units 4 to the respective one of the mounting blocks 32. For each of the second positioning subunits 33, the securing bolt 332 of each of the securing bolt modules 331 engages a corresponding one of the securing holes 412 of the sediment-trapping members 41 of the respective one of the sediment-trapping units 4, and cooperates with the corresponding securing nut 335 to secure the abutment portions 411 of a corresponding one of the sediment-trapping members 41 of the respective one of the sediment-trapping units 4 to the tube structure 31. For each of the second positioning subunits 33, the protecting cap 336 of each of the securing bolt modules 331 abuts against an inner surface of the abutment portion 411 of a corresponding one of the sediment-trapping members 41, such that erosion to the engaging segments 333 of the securing bolts 332 and the securing nut 335 caused by scour of the sediments 901 in the water 900 can be effectively alleviated.

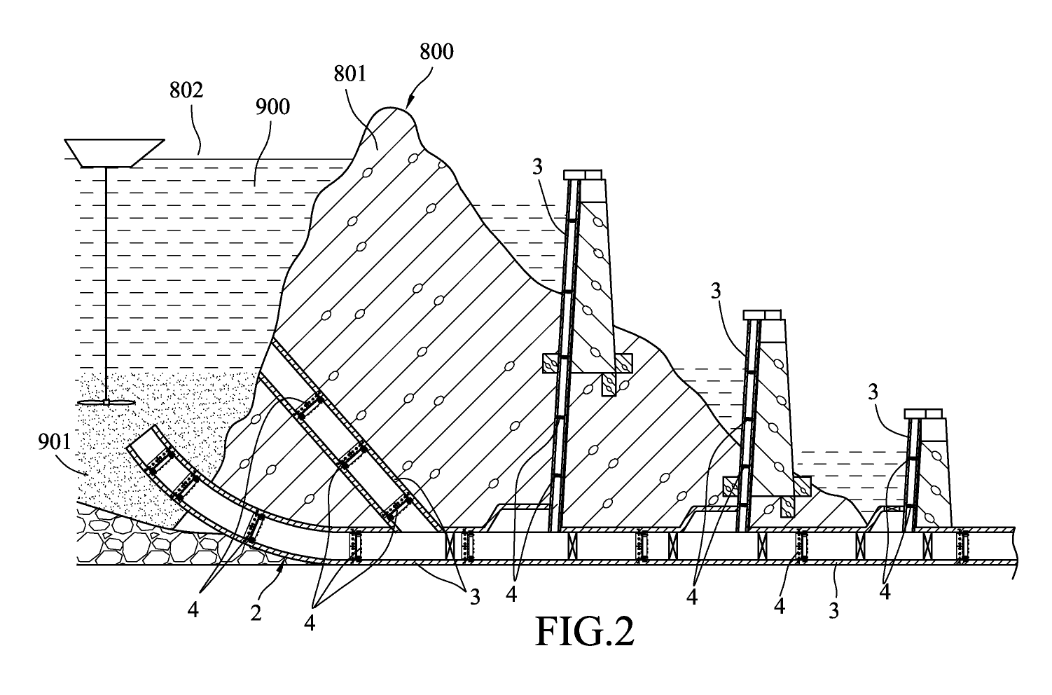

Referring back to FIGS. 2, 4 and 6, when the dredging tube system 2 guides the water 900 with sediments 901 through the water storage 800, at least a portion of sediments 901 carried by the water 900 is trapped by the sediment-trapping units 4 as the water 900 flows within the tube space 310. For each of the sediment-trapping members 41, since the projection portion 413 extends radially and inwardly toward the longitudinal axis, it slows down the sediments 901 proximate to the inner surrounding surface 311 of the tube structure 31, so that the sediments 901 are deposited between each two neighboring sediment-trapping units 4 and become a sediment layer 902 that covers the lower part of the inner surrounding surface 311 of the tube structure 31. With the formation of the sediment layer 902, the inner surrounding surface 311 is protected from wearing due to the abrupt movements of the sediments 901. The flow of the sediments 901 toward the inner surrounding surface 311 is further disrupted by the turbulent flow of water 900 downstream of each of the sediment-trapping units 4, near the downstream surface 322 of the respective mounting blocks 32.

When anyone of the sediment-trapping members 41 of the sediment-trapping units 4 is damaged due to scour of the sediments 901 in the water 900, it can be individually replaced by removing the corresponding securing bolt modules 331 and the corresponding positioning bolt modules 351, instead of having to replace the whole sediment-trapping unit 4. It should be noted that, to prevent the sediments from flowing through the gaps 410 between the sediment-trapping members 41 and damaging the upstream surfaces 321 of the mounting blocks 32, multiple blocks (not shown) may be mounted on the sediment-trapping members 41 or on the tube structure 31 and disposed at an upstream side of the gaps 410.

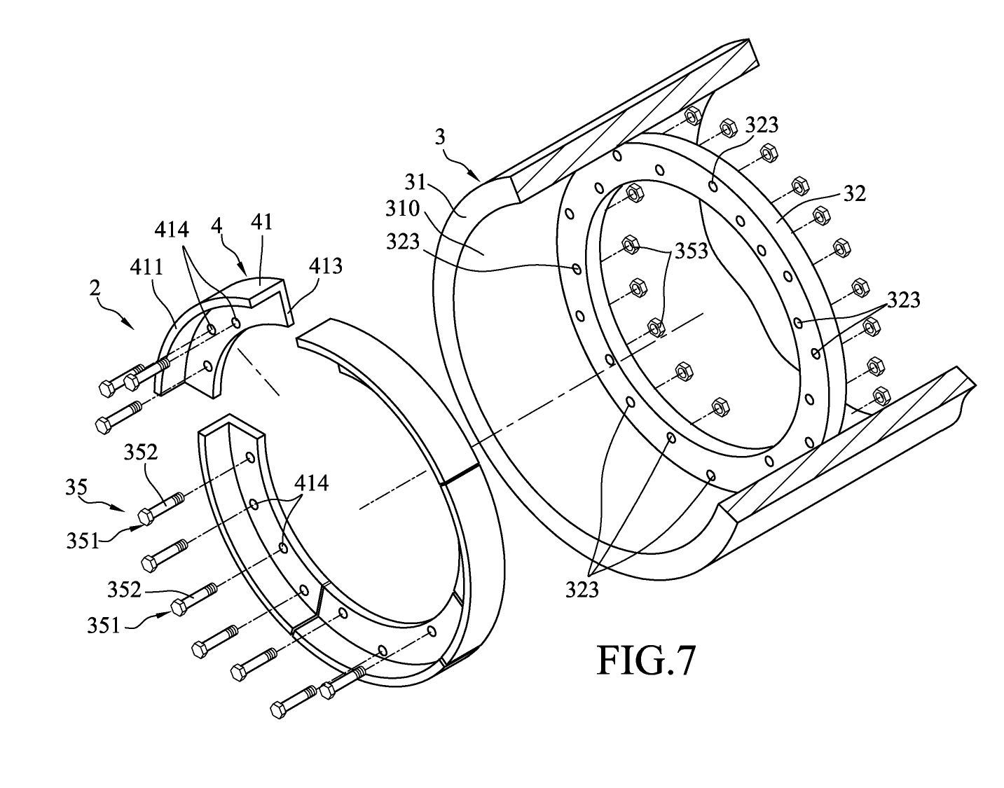

Referring to FIG. 7, a second embodiment of the disclosure is similar to that of the first embodiment. In this embodiment, the connecting members 34, the securing holes 412 and the second positioning subunits 33 which are illustrated in the previous embodiment are absent. The tube structure 31 used in this embodiment is made of pressure-resistant steel, metal, rubber plastic or other types of high polymer materials. The locking holes 323, while angularly spaced-apart, are arranged throughout the mounting blocks 32 without specific pattern. Each of the sediment-trapping members 41 is only secured by a corresponding one of the first positioning subunits 35 to the respective one of the mounting blocks 32.

In summary, the structural design of the tube unit and the flow-disrupting feature of the sediment-trapping units 4 effectively slows down the flow of the sediments 901 carried by the water 900, as well as trapping a portion of sediments 901 at the lower part of the inner surrounding surface 311 of the tube structure 31 between each two neighboring sediment-trapping units 4 to form the sediment layer 902, therefore protecting the tube structure 31 from wearing. In addition, each of the sediment-trapping members 41 may be replaceable if damaged, mitigating the overall cost of maintenance for the dredging tube system 2 as whole.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A dredging tube system comprising:
a tube unit including a tube structure that has an inner surrounding surface surrounding a longitudinal axis of said tube structure and defining a tube space adapted for passage of water; and
a plurality of spaced-apart sediment-trapping units disposed in said tube space, mounted fixedly on said inner surrounding surface, and arranged along the longitudinal axis, each of said sediment-trapping units including a plurality of sediment-trapping members that cooperatively form an annular ring structure surrounding the longitudinal axis, each of said sediment-trapping members having an abutment portion that has a curved outer surface entirely abutting against said inner surrounding surface of said tube structure, and a projecting portion that extends radially and inwardly from said abutment portion, such that at least a portion of sediments carried by the water is trapped by said sediment-trapping units as the water flows within said tube space.

2. The dredging tube system as claimed in claim 1, wherein:
said tube unit further includes a plurality of annular mounting blocks that are disposed in said tube space, that are mounted fixedly on said inner surrounding surface, and that are arranged along the longitudinal axis;
each of said mounting blocks has an upstream surface, a downstream surface that is opposite to said upstream surface along the longitudinal axis, and a plurality of angularly spaced-apart locking holes that extends through said upstream surface and said downstream surface;
for each of said sediment-trapping units, said projecting portions of said sediment-trapping members abut against said upstream surface of a respective one of said mounting blocks, and said projecting portions of each of said sediment-trapping members is formed with a plurality of positioning holes extending parallel to the longitudinal axis and each being registered with a corresponding one of said locking holes of the respective one of said mounting blocks; and
said tube unit further includes a plurality of first positioning subunits, each of which secures a respective one of said sediment-trapping units to a respective one of said mounting blocks, and includes a plurality of positioning bolt modules each engaging a corresponding one of said positioning holes of the respective one of said sediment-trapping units and the corresponding one of said locking holes of the respective one of said mounting blocks.

3. The dredging tube system as claimed in claim 2, wherein said tube unit further includes a plurality of connecting members connecting said mounting blocks to said tube structure.

4. The dredging tube system as claimed in claim 3, wherein each of said connecting members is embedded in said tube structure and a corresponding one of said mounting blocks.

5. The dredging tube system as claimed in claim 2, wherein:
for each of said sediment-trapping units, said abutment portion of each of said sediment-trapping members is formed with a plurality of angularly spaced-apart securing holes that extends radially therethrough; and
said tube unit further includes a plurality of second positioning subunits, each of which secures a respective one of said sediment-trapping units to said inner surrounding surface of said tube structure, and includes a plurality of securing bolt modules each engaging a corresponding one of said securing holes of said sediment-trapping members of the respective one of said sediment-trapping units and said tube structure.

6. The dredging tube system as claimed in claim 5, wherein, for each of said second positioning subunits, each of said securing bolt modules includes:
a securing bolt that has a root segment embedded in said tube structure, and an engaging segment extending from said root segment through said inner surrounding surface and engaging the corresponding one of said securing holes of said sediment-trapping members of the respective one of said sediment-trapping units; and
a securing nut that engages threadedly said securing bolt.

7. The dredging tube system as claimed in claim 6, wherein, each of said securing bolt, said root segment is transverse to said engaging segment.

8. The dredging tube system as claimed in claim 7, wherein each of said securing bolt modules further includes a protecting cap that is disposed in said tube space and that covers and is coupled to a distal end portion of said engaging segment of said securing bolt and said securing nut.
